(19) United States
(12) Patent Application Publication
(10) Pub. No.: US 2020/0198634 A1
(43) Pub. Date: Jun. 25, 2020

(54) VEHICLE CONTROL APPARATUS, VEHICLE, AND VEHICLE CONTROL METHOD

(71) Applicant: HONDA MOTOR CO., LTD., Tokyo (JP)

(72) Inventor: Katsuya YASHIRO, Wako-shi (JP)

(21) Appl. No.: 16/807,551

(22) Filed: Mar. 3, 2020

Related U.S. Application Data
(63) Continuation of application No. PCT/JP2017/033959, filed on Sep. 20, 2017.

(51) Int. Cl. B60W 30/16; G06K 9/00; B60W 60/00

(52) U.S. Cl. CPC B60W 30/162; B60W 60/00274; G06K 9/00805

(57) ABSTRACT

A vehicle control apparatus includes: a setting unit configured to set a distance in a horizontal direction that crosses a traveling direction of a vehicle to a target that may exist in surroundings of the vehicle; a detection unit configured to detect the target existing in the surroundings of the vehicle while the vehicle is traveling; and a control unit configured to execute offset control that moves the vehicle in the horizontal direction, based on comparison between a distance in the horizontal direction to the detected target, and the distance in the horizontal direction set to the target.

### CROSS-REFERENCE TO RELATED APPLICATION(S)

This application is a continuation of International Patent Application No. PCT/JP2017/033959 filed on Sep. 20, 2017, the entire disclosures of which is incorporated herein by reference.

### BACKGROUND OF THE INVENTION

### Field of the Invention

The present invention relates to a vehicle control apparatus, a vehicle, and a vehicle control method.

### Description of the Related Art

PTL1 discloses the configuration of an operation input unit for setting an arbitrary inter-vehicle distance by a driver in inter-vehicular distance control. According to the configuration of PTL1, the driver can arbitrarily set the inter-vehicular distance in a longitudinal direction along a traveling direction as the relative positional relationship between a self-vehicle and the other car traveling in front.

### CITATION LIST

### Patent Literature

PTL1: Japanese Patent Laid-Open No. 6-305340

However, in the configuration of PTL1, a case may occur where the distance in a horizontal direction (offset amount) that crosses the traveling direction of the vehicle cannot be controlled according to the setting by the driver, as the relative positional relationship with respect to a target existing in the surroundings of the self-vehicle.

In light of the above problem, an object of the present invention is to provide a vehicle control technology capable of controlling the distance in the horizontal direction that crosses the traveling direction of the vehicle, as the relative positional relationship with respect to a target existing in the surroundings of the vehicle, according to the setting by the driver.

### SUMMARY OF THE INVENTION

A vehicle control apparatus according to one aspect of the present invention is a vehicle control apparatus that controls traveling of a vehicle, the vehicle control apparatus comprising: a setting unit configured to set a distance in a horizontal direction that crosses a traveling direction of the vehicle to a target that may exist in surroundings of the vehicle; a detection unit configured to detect the target existing in the surroundings of the vehicle while the vehicle is traveling; and a control unit configured to execute offset control that moves the vehicle in the horizontal direction, based on comparison between a distance in the horizontal direction to the detected target, and the distance in the horizontal direction set to the target.

According to the present invention, it is possible to control the distance in the horizontal direction that crosses the traveling direction of a vehicle, as the relative positional relationship with respect to a target existing in the surroundings of the vehicle, according to the setting by a driver.

### BRIEF DESCRIPTION OF THE DRAWINGS

The accompanying drawings are included in the specification, constitute a part thereof, show an embodiment of the present invention, and are used for describing the principle of the present invention with the recitation thereof.

FIG. 1A is a diagram illustrating the basic configuration of a vehicle control apparatus.

FIG. 1B is a diagram showing an exemplary configuration of the control block diagram of the vehicle control apparatus.

FIG. 2A is a diagram showing an exemplary setting of the distance in a horizontal direction according to the type of a target.

FIG. 2B is a diagram showing an exemplary setting of an offset amount according to an automated-driving level.

FIG. 2C is a diagram showing an exemplary setting of the offset amount according to a hands-on state or a hands-off state.

FIG. 3 is a diagram exemplarily describing the offset control that moves a vehicle in the horizontal direction.

FIG. 4 is a diagram illustrating a screen display of a display apparatus.

FIG. 5 is a diagram illustrating a screen display of the display apparatus.

FIG. 6 is a diagram describing the flow of the offset control according to an embodiment.

### DESCRIPTION OF THE EMBODIMENTS

Hereinafter, an embodiment of the present invention will be described with reference to the drawings. The components mentioned in this embodiment are merely illustrations, and are not limited by the following embodiments.

(Configuration of Vehicle Control Apparatus)

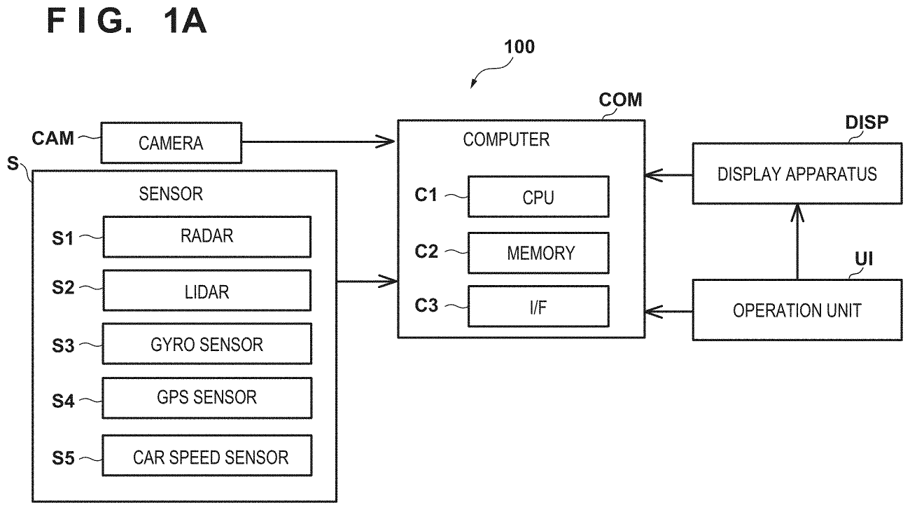

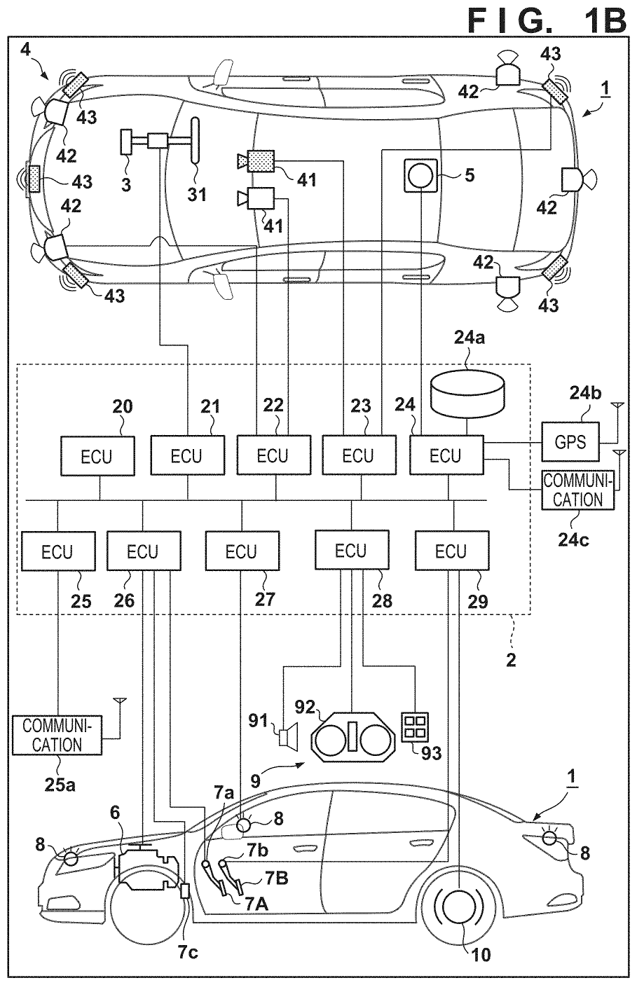

FIG. 1A is a diagram illustrating the basic configuration of a vehicle control apparatus 100 that performs the automated driving control of a vehicle, and the vehicle control apparatus 100 includes a sensor S, a camera CAM, a computer COM, a display apparatus DISP, and an operation unit UI for operating the display apparatus DISP. The sensor S includes, for example, a radar S1, a LIDAR S2, a gyro sensor S3, a GPS sensor S4, a car speed sensor S5, etc.

Additionally, the computer COM includes a CPU (C1) that administers the processing related to the automated driving control of a vehicle, a memory C2, an interface (I/F) C3 for external devices, etc. The sensor S and the camera CAM obtain and input various kinds of information of the vehicle to the computer COM. Here, in the following description, the vehicle mounted with the computer COM is also called a self-vehicle, and a two-wheeled or four-wheeled vehicle, such as a bicycle and a motorbike, existing in the surroundings of the self-vehicle is also called the other vehicle. Here, the four-wheeled vehicle includes, for example, a mini-vehicle, an ordinary vehicle, and a large-sized vehicle, such as a bus and a truck, as the vehicle type.

The computer COM performs image processing on the information input from the sensor S (the radar S1, the LIDAR S2) and the camera CAM, and extracts a target (object) existing in the surroundings of the self-vehicle. The target includes a static target (for example, a static object, such as a white line on a road, a lane, the road width, a pylon, a traffic signal, a telephone pole supporting a traffic signal, a curbstone, and a road structure such as a sign and a guardrail) that does not move over the passage of time, a dynamic target (for example, the other vehicle (a two-wheeled or four-wheeled vehicle such as a bicycle and a motorbike)) that moves over the passage of time, and a moving object such as a pedestrian and a falling object on a road.

The computer COM extract the target from an image obtained by the sensor S (the radar S1, the LIDAR S2) and the camera CAM, and analyzes what kind of target is arranged in the surroundings of the self-vehicle. For example, it is possible to obtain information of the other vehicles traveling in front and behind the self-vehicle in the same lane in which the self-vehicle is traveling, and the other vehicle traveling side by side with the self-vehicle in a lane adjacent to the lane in which the self-vehicle is traveling.

The gyro sensor S3 detects the rotational movement and posture of the self-vehicle. The computer COM can determine the course of the self-vehicle based on the detection result of the gyro sensor S3, the vehicle speed detected by the speed sensor S5, etc. The GPS sensor S4 detects the current position (position information) of the self-vehicle in map information. The interface (I/F) C3 functions as a communication apparatus, performs wireless communication with a server providing the map information and traffic information, and obtains these kinds of information. The computer COM can store the obtained information in the memory C2, which functions as a storage apparatus, can access databases of the map information and the traffic information built in the memory C2, and can perform route search from the current location to a destination, etc.

The display apparatus DISP displays information for setting the distance in the horizontal direction that crosses the traveling direction of a vehicle 1 as the relative positional relationship with respect to the target existing in the surroundings of the self-vehicle. Additionally, the operation unit UI functions as a user interface, and receives an operational input by the driver regarding the setting of the distance in the horizontal direction for the target existing in the surroundings of the self-vehicle.

For example, it is possible to configure the display apparatus DISP as a touch panel, and to integrally configure the display apparatus DISP and the operation unit UI. In this case, it is possible to input an operation from the operation unit UI to the computer COM via the display apparatus DISP. Additionally, it is also possible to configure the operation unit UI as an input apparatus, such as a switch and a button, and to input the operation from the operation unit UI to the computer COM. Based on the operation input of the operation unit UI, the computer COM controls the distance in the horizontal direction that crosses the traveling direction according to the setting by the driver for the target existing in the surroundings of the self-vehicle.

In a case where the vehicle control apparatus 100 shown in FIG. 1A is mounted in a vehicle, the computer COM may be arranged in, for example, an ECU of a recognition processing system that processes the information of the sensor S and the camera CAM or an ECU of an image processing system, may be arranged in an ECU controlling an input/output apparatus, or may be arranged in an ECU within a control unit that performs drive control of the vehicle, or an ECU for automated driving. For example, as in FIG. 1B described below, functions may be distributed to a plurality of ECUs constituting the vehicle control apparatus 100, such as an ECU for the sensor S, an ECU for the camera, an ECU for the input/output apparatus, and an ECU for automated driving.

FIG. 1B is a diagram showing a configuration example of the control block diagram of the vehicle control apparatus 100 for controlling the vehicle 1. In FIG. 1B, the outline of the vehicle 1 is shown by a plan view and a side view. The vehicle 1 is a sedan-type four-wheeled passenger car as an example.

A control unit 2 in FIG. 1B controls each part of the vehicle 1. The control unit 2 includes a plurality of ECUs 20 to 29 communicably connected by an in-vehicle network. Each ECU (Electronic Control Unit) includes a processor represented by a CPU (Central Processing Unit), a storage device such as a semiconductor memory, an interface for external devices, etc. The storage device stores a program executed by the processor, data used for processing by the processor, etc. Each ECU may include a plurality of processors, storage devices, interfaces, etc.

Hereinafter, the functions handled by each of the ECUs 20 to 29 etc. will be described. Note that the number of the ECUs and the functions handled by the ECUs can be properly designed for the vehicle 1, and can be more subclassified than those in the present embodiment, or can be unified.

The ECU 20 performs vehicle control related to the automated driving of the vehicle 1 (self-vehicle) according to the present embodiment. In the automated driving, at least one of the steering and the acceleration and deceleration of the vehicle 1 is automatically controlled. The processing related to specific control in connection with the automated driving will be described in detail later.

The ECU 21 controls an electric power steering apparatus 3. The electric power steering apparatus 3 includes a mechanism that steers front wheels according to the driver's driving operation (steering operation) to a steering wheel 31. Additionally, the electric power steering apparatus 3 includes a motor that exhibits a driving force for assisting the steering operation or automatically steering the front wheels, a sensor that detects the steering angle, etc. In a case where the driving status of the vehicle 1 is automated driving, the ECU 21 automatically controls the electric power steering apparatus 3 in response to an instruction from the ECU 20, and controls the moving direction of the vehicle 1.

The ECUs 22 and 23 control detection units 41 to 43 that detect the surrounding condition of the vehicle, and perform information processing of the detection result. The detection unit 41 is, for example, a camera that photographs a forward area of the vehicle 1 (hereinafter may be written as the camera 41), and in the case of the present embodiment, two detection units 41 are provided in a front portion of the roof of the vehicle 1. By analyzing an image photographed by the camera 41 (image processing), it is possible to extract the outline of a target, and to extract the classification lines (white lines, etc.) of lanes on a road.

The detection unit 42 (LIDAR detection unit) is, for example, a LIDAR (Light Detection and Ranging (LIDAR)) (hereinafter may be written as the LIDAR 42), and detects a target in the surroundings of the vehicle 1 with light, and ranges the distance to the target. In the case of the present embodiment, a plurality of LIDARs 42 are provided on the exterior of the vehicle. In the example shown in FIG. 1B, for example, five LIDARs 42 are provided: one in each of the corners of the front portion, one in the middle of a rear portion, and one in each of the sides of the rear portion of the vehicle 1. The detection unit 43 (radar detection unit) is, for example, a millimeter wave radar (hereinafter may be written as the radar 43), and detects a target in the surroundings of the vehicle 1 with an electric wave, and ranges the distance to the target. In the case of the present embodiment, a plurality of radars 43 are provided on the exterior of the vehicle. In the example shown in FIG. 1B, for example, five radars 43 are provided: one in the middle of the front portion, one in each of the corners of the front portion, and one in each of the corners of the rear portion of the vehicle 1.

The ECU 22 controls one of the cameras 41 and each of the LIDARs 42, and performs information processing of the detection result. The ECU 23 controls the other one of the cameras 41 and each of the radars 43, and performs information processing of the detection result. Since two sets of apparatuses that detect the surrounding condition of the vehicle are provided, the reliability of the detection result can be improved, and since different kinds of detection units, such as the cameras, the LIDARs, and the radars, are provided, the analysis of the surrounding environment of the vehicle can be performed from many aspects. Note that the ECU 22 and the ECU 23 may be combined into one ECU.

The ECU 24 controls a gyro sensor 5, a GPS sensor 24b, and a communication apparatus 24c, and performs information processing of the detection result or a communication result. The gyro sensor 5 detects the rotational movement of the vehicle 1. The course of the vehicle 1 can be determined based on the detection result of the gyro sensor 5, the wheel speed, etc. The GPS sensor 24b detects the current position of the vehicle 1. The communication apparatus 24c performs wireless communication with the server that provides the map information and the traffic information, and obtains these kinds of information. The ECU 24 can access a database of the map information 24a built in a storage device, and the ECU 24 performs route search from the current location to a destination, etc. The database 24a can be arranged on a network, and the communication apparatus 24c can access the database 24a on the network, and obtain the information.

The ECU 25 includes a communication apparatus 25a for car-to-car communication. The communication apparatus 25a performs wireless communication with the surrounding other vehicles, and performs information exchange between the vehicles.

The ECU 26 controls a power plant 6. The power plant 6 is a mechanism that outputs the driving force for rotating driving wheels of the vehicle 1, and includes, for example, an engine and a gearbox. The ECU 26 controls the output of the engine in response to, for example, the driver's driving operation (accelerator operation or accelerating operation) detected by an operation detecting sensor 7a provided in accelerator pedal 7A, and switches the gear ratio of the gearbox based on information such as the vehicle speed detected by a vehicle speed sensor 7c, etc. In a case where the driving status of the vehicle 1 is automated driving, the ECU 26 automatically controls the power plant 6 in response to an instruction from the ECU 20, and controls the acceleration and deceleration of the vehicle 1.

The ECU 27 controls lighting devices (headlights, taillights, etc.) including blinkers 8. In the case of the example of FIG. 1B, the blinkers 8 are provided in the front portion, door mirrors, and the rear portion of the vehicle 1.

The ECU 28 controls an input/output apparatus 9. The input/output apparatus 9 outputs information to the driver, and receives an input of information from the driver. An audio output apparatus 91 reports information to the driver with audio. A display apparatus 92 reports information to the driver by displaying images. The display apparatus 92 is arranged, for example, on a surface of a driver's seat, and constitutes an instrument panel, etc. Note that, here, although the audio and display are illustrated, information may be reported with vibration or light. Additionally, information may be reported by combining a plurality of audio, display, vibration, or light. Further, depending on the level (for example, urgency) of information to be reported, the combination may be changed, or a reporting mode may be changed.

Although an input apparatus 93 is a switch group that is arranged at a position to allow operation by the driver, and with which the driver gives instructions to the vehicle 1, the input apparatus 93 may also include an audio input apparatus. The display apparatus 92 corresponds to, for example, the display apparatus DISP in FIG. 1A described previously, and the input apparatus 93 corresponds to the configuration of the operation unit UI in FIG. 1A.

The ECU 29 controls a brake apparatus 10 and a parking brake (not shown). The brake apparatus 10 is, for example, a disc brake apparatus, and is provided in each of the wheels of the vehicle 1, and the vehicle 1 is decelerated or stopped by applying resistance to the rotation of the wheels. The ECU 29 controls the actuation of the brake apparatus 10 in response to, for example, the driver's driving operation (brake operation) detected by an operation detecting sensor 7b provided in a brake pedal 7B. In a case where the driving status of the vehicle 1 is automated driving, the ECU 29 automatically controls the brake apparatus 10 in response to an instruction from the ECU 20, and controls deceleration and stoppage of the vehicle 1. The brake apparatus 10 and the parking brake can also be actuated in order to maintain the stopped state of the vehicle 1. Additionally, in a case where the gearbox of the power plant 6 includes a parking lock mechanism, this can also be actuated in order to maintain the stopped state of the vehicle 1.

In vehicle control of the present embodiment, the ECU 22 shown in FIG. 1B performs information processing of the detection results of one of the cameras 41 and each of the LIDARs 42, and the ECU 23 performs information processing of the detection results of the other one of the cameras 41 and each of the radars 43. The ECU 20 can obtain information of a target (for example, the other vehicle, a guardrail, etc.) located in the surroundings of the vehicle 1 (self-vehicle) based on the results of the information processing by the ECU22 and the ECU 23. For example, it is possible to obtain information about the position, the relative distance (interval), the speed, etc. of the other vehicle traveling side by side with the self-vehicle in a lane adjacent to the lane in which the self-vehicle is traveling. Additionally, the relative distance to a structure, such as a guardrail, existing at a side of the self-vehicle can be obtained.

Additionally, the ECU 28, which controls the display apparatus 92 and the input apparatus 93, functions as a display control unit, displays information for setting the distance in the horizontal direction that crosses the traveling direction of the vehicle, and performs information processing based on an operation input.

The ECU 20, which performs vehicle control related to automated driving, controls the distance in the horizontal direction that crosses the traveling direction for a target existing in the surroundings of the vehicle 1, based on the set distance in the horizontal direction, according to the setting by the driver. The ECU 20 controls the distance to the static target (for example, the distance to a structure such as a guardrail) based on a set value that is set by the driver, while controlling the distance to the dynamic target (for example, the lateral distance to the other vehicle traveling side by side) based on a set value that is set by the driver. That is, the ECU 20 controls how distant or how close various targets existing in the surroundings of the vehicle 1 can be, based on the setting by the driver.

(Setting of Distance in Horizontal Direction)

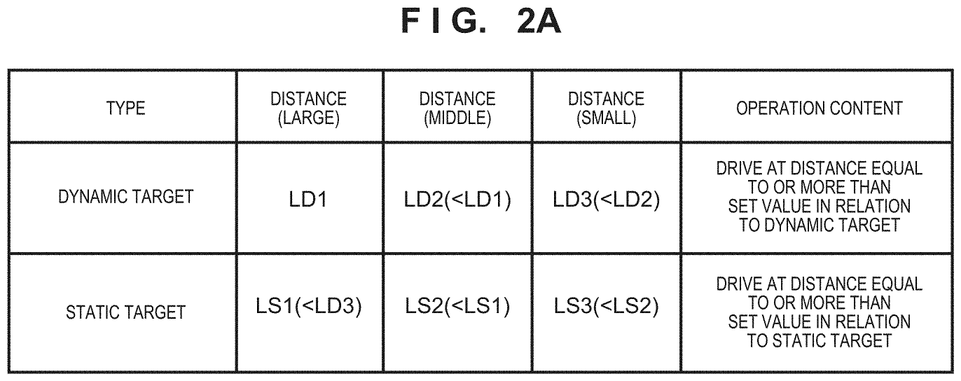

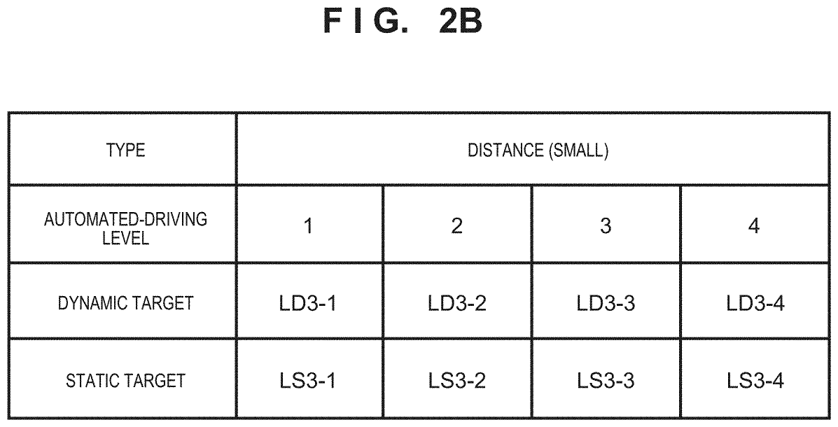

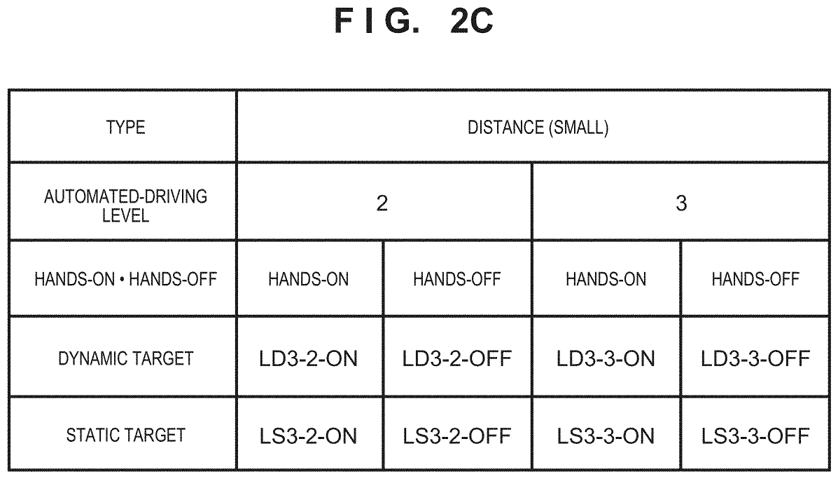

In the present embodiment, the distance in the horizontal direction can be set with a plurality of stages, or a plurality of levels that change continuously. FIG. 2A is a diagram showing an exemplary setting of the distance in the horizontal direction according to the type of a target, and in FIG. 2A, the exemplary setting is shown in which the distance in the horizontal direction is divided into the three stages (large, middle, small).

Here, the dynamic target is a target that moves over the passage of time, and includes, for example, a two-wheeled or four-wheeled vehicle such as a bicycle and a motorbike, a pedestrian, and a movable object such as a falling object on a road. Additionally, the four-wheeled vehicle can be further subclassified according to the vehicle type: for example, a mini-vehicle, an ordinary vehicle, and a large-sized vehicle, such as a bus and a truck.

The static target is a target that does not move over the passage of time, and includes a static object, such as a white line on a road, a lane, the road width, a pylon, a traffic signal, a telephone pole supporting a traffic signal, a curbstone, and a road structure such as a sign and a guardrail.

Note that static targets can be classified into those with height (for example, a pylon, a traffic signal, a telephone pole supporting a traffic signal, a curbstone, and a road structure such as a sign and a guardrail), and those without height (a white line on a road, a lane, the road width, etc.).

In FIG. 2A, with respect to the dynamic target, a distance LD1 is set to the distance (large), a distance LD2 is set to the distance (middle), and a distance LD3 is set to the distance (small). The size relationship among the set values is LD1>LD2>LD3

Additionally, with respect to the static target, a distance LS1 is set to the distance (large), a distance LS2 is set to the distance (middle), and a distance LS3 is set to the distance (small). The size relationship among the set values is LS1>LS2>LS3. Further, a value smaller than the set value LD3 of the distance (small) of the dynamic target is set to the set value LS1 of the distance (large) of the static target. That is, the size relationship is LS1<LD3.

The set value of the distance (large), the set value of the distance (medium), and the set value of distance (small) for the dynamic target are set larger than the set value of the distance (large), the set value of the distance (medium), and the set value of the distance (small) for the static target, respectively. Although the set values as the examples shown in FIG. 2A are applied to each of the dynamic target and the static target, it is possible to define set values by further subclassifying each of the targets. For example, it is also possible to be subclassified into a pedestrian, a bicycle, a motorbike, a four-wheeled vehicle, etc., or to further subclassify a four-wheeled vehicle according to the vehicle type: for example, a mini-vehicle, an ordinary vehicle, and a large-sized vehicle, such as a bus and a truck. Additionally, it is also possible to subclassify the static target into those with height and those without height.

Although in the example shown in FIG. 2A, the exemplary setting of the distance in the horizontal direction corresponding to the type of the target is shown, in a case where there are a plurality of drivers who can drive the vehicle 1, identification information may be set to each driver, and set values may be maintained for each of the drivers. Further, it is also possible to maintain the set values according to the type of road, such as a highway and a general road, and the speed range of the vehicle 1, and to switch the set values according to the traveling condition of the vehicle 1 and the driving driver.

Further, in a case of manual driving by the driver, the ECU 20 may store data about how distant from a target driving is performed, perform learning based on stored results, and set the distances to the dynamic target and the static target based on learned results. In this manner, it is possible to perform traveling that reflects the distance setting more adapted to the driver's driving feeling to the automated driving.

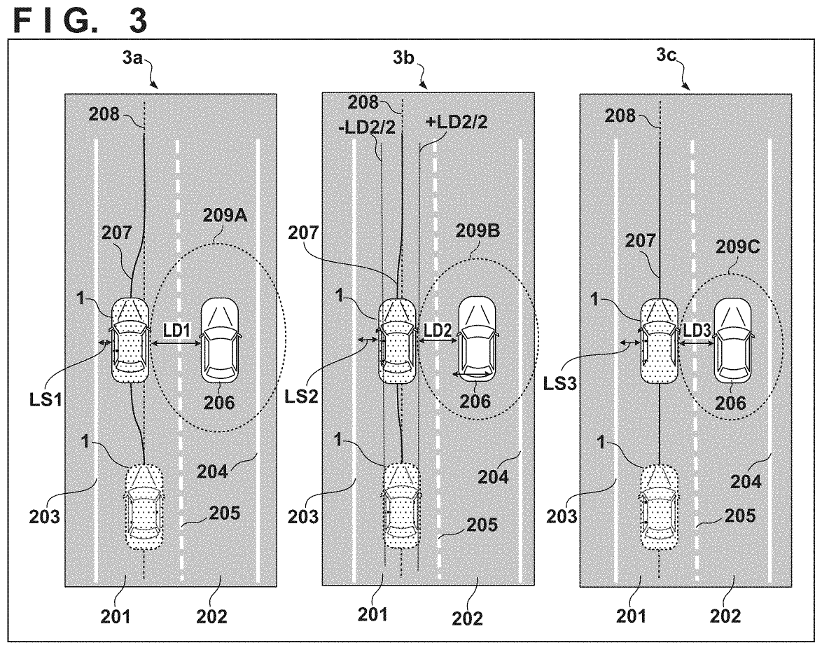

FIG. 3 is a diagram exemplarily describing offset control that moves a vehicle in the horizontal direction. 3a of FIG. 3 is a diagram exemplarily describing control of the offset amount in a case where the driver sets the distance (large) in FIG. 2A, 3b of FIG. 3 is a diagram exemplarily describing control of the offset amount in a case where the driver sets the distance (medium) in FIG. 2A, and 3c of FIG. 3 is a diagram exemplarily describing control of the offset amount in a case where the driver sets the distance (small).

In 3a to 3c of FIG. 3, a lane 201 is defined by, for example, a target (static target 203) corresponding to a white line or a guardrail, etc., which is the static target, and by a segment line 205 (white line) indicating the lane boundary of a lane 202 adjacent to the lane 201. Additionally, the lane 202 adjacent to the lane 201 is defined by the segment line 205 (white line) and a target 204 corresponding to a white line or a guardrail, etc.

The vehicle 1 (self-vehicle) indicated by a broken line shows a state where the vehicle 1 is traveling along a lane center 208 indicated by a one-dot-chain line, and the vehicle 1 (self-vehicle) indicated by a solid line shows a state where the offset control is being performed. A solid line 207 indicates the moving track of the vehicle 1 (self-vehicle) in the case of the offset control. As the dynamic target existing in the surroundings of the vehicle 1 (self-vehicle) indicated by a solid line, the other vehicle 206 is traveling in the lane 202 adjacent to the lane 201. An ellipse 209 indicated by a broken line schematically shows the size of the distance (LD1 to LD3) secured between the vehicle 1 and the other vehicle 206 in the offset control.

As shown in 3a of FIG. 3, in the offset control based on the setting of the distance (large), it is possible to approach the static target 203 up to LS1, while securing LD1 as the distance to the other vehicle 206 traveling side by side with the vehicle 1 (self-vehicle).

Additionally, in 3b of FIG. 3, in the offset control based on the setting of the distance (middle), it is possible to approach the static target 203 up to LS2, while securing LD2 as the distance to the other vehicle 206 traveling side by side with the vehicle 1 (self-vehicle).

The width of some road is set to, for example, 3.5 m in a driving lane and 3.75 m in a fast lane on a highway, the width of other roads is set to a range between 3.25 to 3.75 m, and the average is substantially 3.5 m. Additionally, in general roads, it is set to a range between 2.75 m to 3.5 m. The vehicle width is, for example, about 2.1 m in a large vehicle, and is about 1.9 m even in a large-sized sedan.

When it is assumed that an example of the road width is 3.5 m, and an example of the vehicle width is 1.9 m, in a case where a vehicle having a width of 1.9 m passes a lane having a road width of 3.5 m, when the vehicle is traveling at the lane center, the respective gaps between the left and right sides of the vehicle width and the edges of the lane is 0.8 m (=(3.5-1.9)×0.5).

Accordingly, as the distance in the horizontal direction (offset amount), it is possible to perform the offset control within a range that does not deviates to the outside of a lane (off-road), when a variation range (a range between −LD2/2 to LD2/2 shown in 3b of FIG. 3) is ±0.8 m on the basis of the lane center (for example, the lane center 208 indicated by the one-dot-chain line in 3b of FIG. 3). When the lane width and the vehicle width are mutually the same, in a case where each of the vehicles travels the lane center, the vehicles will travel side by side with each other with an interval of 1.6 m.

Next, as shown in 3c of FIG. 3, in the offset control based on the setting of the distance (small), it is possible to approach the static target 203 up to LS3, while securing LD3 as the distance to the other vehicle 206 traveling side by side with the vehicle 1 (self-vehicle). As shown in 3c of FIG. 3, in the offset control based on the setting of the distance (small), the moving track of the solid line 207 matches the lane center 208, and even if the vehicle 1 performs the offset control, it is possible to move along the lane center 208 in the relative positional relationship with the other vehicle 206 traveling side by side.

By setting a larger value to the set value of the distance to the dynamic target than the set value of the distance to the static target, the ECU 20 performs the offset control so that the vehicle 1 well avoids approaching the dynamic target to which the driver easily feel fear. Since the ECU 20 performs the offset control based on the set value by the driver, it is possible to perform the automated driving consistent with the driver's driving feeling.

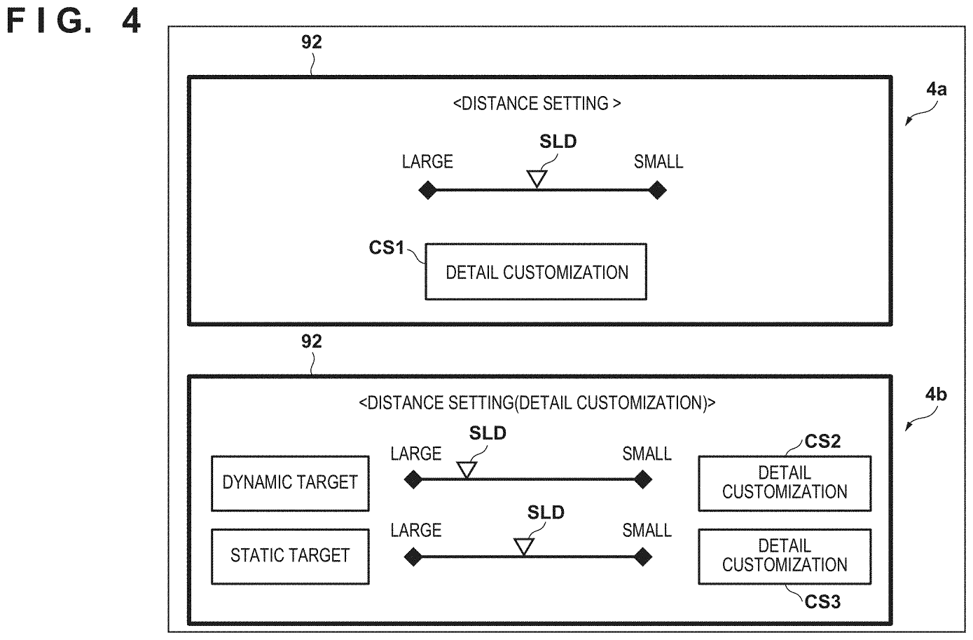

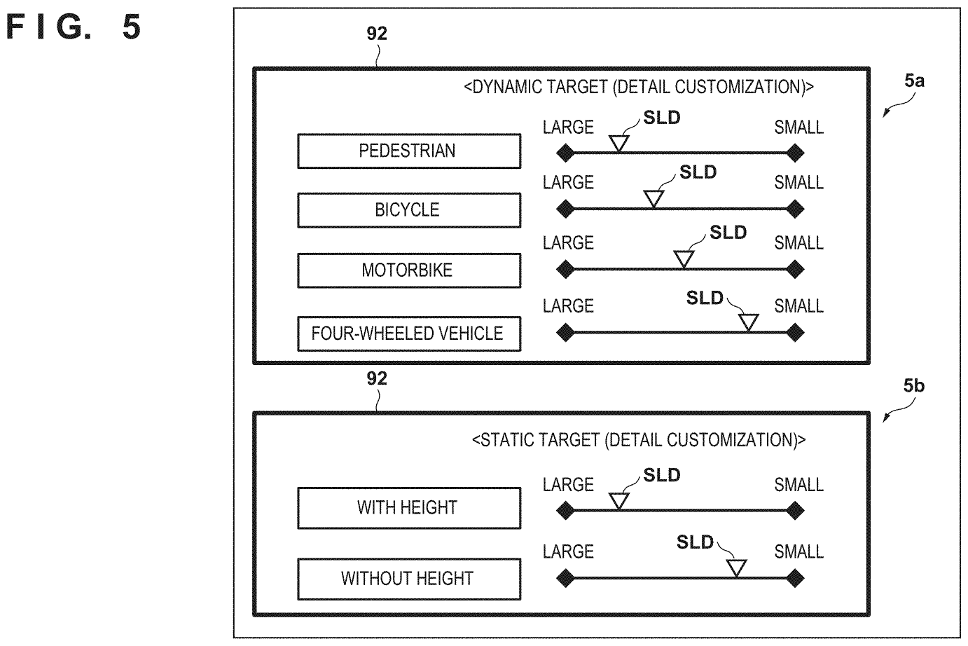

FIG. 4 and FIG. 5 are diagrams illustrating screen displays of the display apparatus 92. As shown in 4a of FIG. 4, a slider SLD that allows stepless volume adjustment is displayed on a screen of the display apparatus 92, and it is possible to set the distance in the horizontal direction (offset amount) by moving this slider SLD on the screen. When the driver selects a detail customization button CS1, the screen display is switched under the display control by the ECU 28, and a detail customization screen for distance setting such as 4b of FIG. 4 is displayed.

As shown in 4b of FIG. 4, in the detail customization screen for distance setting, in order to perform distance setting related to the dynamic target and the static target, sliders SLDs that allow stepless volume adjustment are displayed. For example, when the slider SLD is moved to “large” in the dynamic target, the value of the distance LD1 (large) shown in FIG. 2A is set, and when the slider SLD is moved to “small”, the value of the distance LD3 (small) shown in FIG. 2A is set. When the driver adjusts the position of the slider SLD to an arbitrary position between “large” and “small”, the ECU 28 calculates the value interpolated from the values of the distance LD1 (large) and the distance LD3 (small), and sets it as the value of LD2 (middle). The same also applies to the static target.

In the screen display of 4b of FIG. 4, when the driver selects a detail customization button CS2 of the dynamic target, the screen display is switched under the display control by the ECU 28, and a detail customization screen for the dynamic target such as 5a of FIG. 5 is displayed.

Additionally, when the driver selects a detail customization button CS3 of the static target, the screen display is switched under the display control by the ECU 28, and a detail customization screen for the static target such as 5b of FIG. 5 is displayed.

In the detail customization screen for the dynamic target as shown in 5a of FIG. 5, the dynamic target is classified into, for example, a pedestrian, a bicycle, a motorbike, and a four-wheeled vehicle, and different distances are set. A slider SLD that allows stepless volume adjustment is displayed for each of the subclassified items.

For example, when the slider SLD is moved to “large” in the pedestrian, the value of the distance LD1 (large) shown in FIG. 2A is set as the distance in the horizontal direction (offset amount) for the pedestrian, and when the slider SLD is moved to “small”, the value of the distance LD3 (small) shown in FIG. 2Ais set as the distance in the horizontal direction (offset amount).

When the driver adjusts the position of the slider SLD to an arbitrary position between “large” and “small”, the ECU 28 calculates the value interpolated by the values of the distance LD1 (large) and the distance LD3 (small), and sets it as the value of LD2 (middle). The same applies to the setting to the bicycle, the motorbike, and the four-wheeled vehicle in the dynamic target. Additionally, a detail customization screen may be displayed that further classifies the four-wheeled vehicle according to the size of the vehicle (for example, a mini-vehicle, an ordinary vehicle, a large-sized vehicle, such as a bus and a truck, etc.).

In the exemplary setting shown in 5a of FIG. 5, for the dynamic target, the distance to the bicycle is set smaller than the distance to the pedestrian, the distance to the motorbike is set smaller than the distance to the bicycle, and the distance to the four-wheeled vehicle is set smaller than the distance to the motorbike. By performing the setting as in the exemplary setting shown in 5a, it is possible to perform more safety-conscious automated driving by setting the distances to the pedestrian and the bicycle, which are vulnerable road users, larger than the distances to the motorbike and the four-wheeled vehicle.

Additionally, in the detail customization screen for the static target as shown in 5b of FIG. 5, the static target is classified into the static target with height with respect to the road where the vehicle travels, and the static target without height with respect to the road, and different distances are set. The static target is classified into, for example, those with height, such as a pylon, a traffic signal, a telephone pole supporting a traffic signal, a curbstone, and a road structure such as a sign and a guardrail, or those without height, such as a white line on a road, and different distances are set. The slider SLD that allows stepless volume adjustment is displayed for each of the subclassified items.

For example, when the slider SLD is moved to “large” for the static target with height, the value of the distance LS1 (large) shown in FIG. 2A is set to the static target with height, and when the slider SLD is moved to “small”, the value of the distance LS3 (small) shown in FIG. 2A is set.

When the driver adjusts the position of the slider SLD to an arbitrary position between “large” and “small”, the ECU 28 calculates the value interpolated from the values of the distance LS1 (large) and the distance LS3 (small), and sets it as the value of LS2 (middle). The same also applies to the setting of the distance to the static target without height.

In the exemplary setting shown in 5b of FIG. 5, for the static target, the distance to the static target without height with respect to the road where the vehicle travels is set smaller than the distance to the static target with height with respect to the road. By performing the setting as in the exemplary setting shown in 5b, it is possible to perform automated driving on a track that is comfortable for the driver by setting a larger distance to the static target with height.

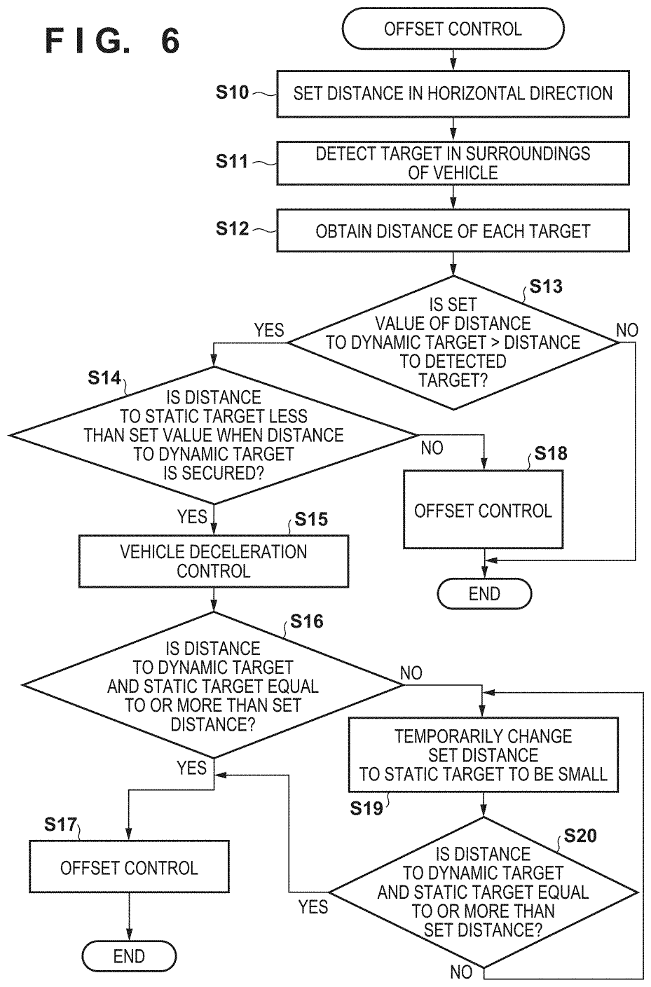

FIG. 6 is a diagram describing the flow of the offset control according to the present embodiment. In step S10, the driver sets the distance in the horizontal direction (offset amount). As described in FIG. 4 and FIG. 5, the distance in the horizontal direction (offset amount) that crosses the traveling direction of the vehicle 1 can be set for the dynamic target and the static target by adjusting the slider SLD on the screen display of the display apparatus 92. Based on the operation by the driver, the ECU 28 and the display apparatus 92 set the distance in the horizontal direction (offset amount) that crosses the traveling direction of the vehicle to the target that may exist in the surroundings of the vehicle 1.

In step S11, the target existing in the surroundings of the vehicle 1 is detected while the vehicle 1 is traveling. The ECU 22 performs information processing of the detection results of one of the cameras 41 and each of the LIDARs 42, the ECU 23 performs information processing of the detection results of the other one of the cameras 41 and each of the radars 43, and the ECU 22 and the ECU 23 input the processing results to the ECU 20.

In step S12, the ECU 20 obtains information of a target located in the surroundings of the vehicle 1 (self-vehicle) based on the results of information processing by the ECU 22 and the ECU 23. For example, the ECU 20 obtains information about the position of the other vehicle 206 traveling side by side with the vehicle 1 (self-vehicle) in the lane adjacent to the lane (for example, 201 in 3a to 3c of FIG. 3) in which the vehicle 1 (self-vehicle) is traveling, the relative distance (interval), etc. Additionally, the ECU 20 obtains information about the position of the static target (for example, 203 in 3a to 3c of FIG. 3) such as a guardrail existing at a side of the vehicle 1 (self-vehicle), the relative distance (interval), etc. With the above processing, the ECU 20 obtains the distances in the horizontal direction to the detected targets (the dynamic target, the static target).

In step S13, the ECU 20 compares the set value of the distance to the dynamic target (set value of the distance to the dynamic target) with the distance (distance in the horizontal direction) to the detected dynamic target. In a case where the distance (distance in the horizontal direction) to the detected dynamic target is equal to or more than the set value of the distance (S13-No), the ECU 20 does not perform the offset control, and terminates this processing.

On the other hand, in the comparison processing in step S13, in a case where the distance (distance in the horizontal direction) to the detected dynamic target is smaller than the set value of the distance to the dynamic target, i.e., in a case where the dynamic target traveling side by side is approaching the vehicle 1 (self-vehicle) less than the set value of the distance to the dynamic target (S13-Yes), the ECU 20 proceeds the processing to step S14.

In a case where the LIDARs 42 and the radars 43 detect a plurality of targets existing in the surroundings of the vehicle 1, the ECU 20 executes the offset control that moves the vehicle in the horizontal direction, based on the comparison between the distance in the horizontal direction to each of the plurality of detected targets, and the distance in the horizontal direction set to the target. Although the description in the following step S14 exemplarily describes the processing related to the dynamic target and the static target as the plurality of targets, the processing may be for dynamic targets, or may be for static targets.

In step S14, in order to secure the set value of the distance to the dynamic target, the ECU 20 determines whether the distance in the horizontal direction between the vehicle 1 (self-vehicle) and the static target is less than the set value of the distance to the static target, when the vehicle 1 (self-vehicle) is horizontally moved (offset movement). In a case where, even if horizontal movement (offset movement) is performed, the distance between the vehicle 1 (self-vehicle) and the static target is not less than the set value of the distance (S14-No), i.e., in a case where, even if the vehicle 1 (self-vehicle) is horizontally moved (offset movement), the vehicle 1 (self-vehicles) is distant from the static target equal to or more than the set value of the distance, the ECU 20 proceeds the processing to step S18.

In step S18, the ECU 20 performs the offset control in order to secure the set value of the distance to the dynamic target, and terminates this processing.

On the other hand, in the determination in step S14, in a case where the vehicle 1 (self-vehicle) is horizontally moved (offset movement) in order to secure the set value of the distance to the dynamic target, when the vehicle 1 (self-vehicle) approaches the static target exceeding the set value of the distance to the static target (S14-Yes), the ECU 20 proceeds the processing to step S15.

In step S15, the ECU 20 performs deceleration control of the vehicle 1. By decelerating the speed of the traveling vehicle 1, it is possible to wait in a deceleration state for the other vehicle 206 to move on, and change the positional relationship with the other vehicle 206 traveling side by side.

Next, in step S16, the ECU 20 determines whether the set value of the distance can be secured for each of the dynamic target and the static target. That is, in a state where the deceleration control is performed, the ECU 20 determines whether the distance in the horizontal direction to each of the dynamic target and the static target (detected distance in the horizontal direction) is equal to or more than the set distance in the horizontal direction (set distance). In a case where the distance in the horizontal direction (detected distance in the horizontal direction) to each of the dynamic target and the static target is equal to or more than the set distance in the horizontal direction (set distance), and the set value of the distance can be secured for each of the dynamic target and the static target (S16-Yes), the ECU 20 proceeds the processing to step S17. Next, in step S17, the ECU 20 performs the offset control, and terminates this processing.

On the other hand, in the determination in step S16, in a case where the ECU 20 determines that the detected distance in the horizontal direction of at least one of the dynamic target and the static target (detected distance in the horizontal direction) is less than the set distance in the horizontal direction (set distance), i.e., in a case where the ECU 20 determines that the set value of the distance cannot be secured for at least one of the dynamic target and the static target (S16-No), the ECU 20 proceeds the processing to step S19.

In step S19, in a state where the deceleration control is performed, in a case where the detected distance in the horizontal direction is less than the set distance in the horizontal direction for at least one of the dynamic target and the static target, the ECU 20 temporarily changes the distance in the horizontal direction set to the static target to be small, and proceeds the processing to step S20.

As the set value of the distance to the static target, there are, for example, the set value LS1 of the distance (large), the set value LS2 of the distance (middle), and the set value LS3 of a distance (small) shown in FIG. 2A, etc. When changing the set value of the distance to be small, for example, it is not limited to a case where the set value is made small in a range between LS1 to LS3, and may be changed to a lower limit that is smaller than the range between LS1 and LS3. For example, the distance to the static target (LS) may be set in a range that is larger than zero, and is smaller than the set value LS3 of the distance (small) (0<LS<LS3). In this manner, since the set value of the distance to the dynamic target is secured by temporarily changing the set value of the distance to the static target, it is possible to travel with a safer sense of distance without excessive deceleration, by temporarily permitting the detected distance to be less than the distance set to the static target.

Next, in step S20, the ECU 20 determines whether the set value of the distance can be secured for each of the dynamic target and the static target. That is, in a state where the deceleration control is performed, and in a state where the set distance to the static target has been temporarily changed, the ECU 20 determines whether the distance in the horizontal direction to each of the dynamic target and the static target (detected distance in the horizontal direction) is equal to or more than the set distance in the horizontal direction (set distance). In a case where the distance in the horizontal direction to each of the dynamic target and the static target (detected distance in the horizontal direction) is equal to or more than the set distance in the horizontal direction (set distance), and the set value of the distance can be secured for each of the dynamic target and the static target (S20-Yes), the ECU 20 proceeds the processing to step S17. Next, in step S17, the ECU 20 performs the offset control, and terminates this processing.

On the other hand, in the determination in step S20, in a case where the ECU 20 determines that the detected distance in the horizontal direction of at least one of the dynamic target and the static target (detected distance in the horizontal direction) is less than the set distance in the horizontal direction (set distance), i.e., in a case where the ECU 20 determines that the set value of the distance of at least one of the dynamic target and the static target cannot be secured (S20-No), the ECU 20 returns the processing to step S19, and again, the ECU 20 temporarily further changes the set value of the distance to the static target to be further smaller, and proceeds the processing to step S20.

Next, in step S20, again, in a state where the deceleration control is performed, and in a state where the set distance to the static target has been temporarily further changed, the ECU 20 determines whether the distance in the horizontal direction to each of the dynamic target and the static target (detected distance in the horizontal direction) is equal to or more than the set distance in the horizontal direction (set distance).

In a case where the distance in the horizontal direction to each of the dynamic target and the static target (detected distance in the horizontal direction) is equal to more than the set distance in the horizontal direction (set distance), and the set value of the distance can be secured for each of the dynamic target and the static target (S20-Yes), the ECU 20 proceeds the processing to step S17. Next, in step S17, the ECU 20 performs the offset control, and terminates this processing.

In the determination in step S20, in a case where the ECU 20 determines that the set value of the distance cannot be secured for at least one of the dynamic target and the static target (S20-No), the ECU 20 returns the processing to step S19 to repeat the same processing, and in a case where the set value of the distance can be secured for each of the dynamic target and the static target (S20-Yes), the ECU 20 proceeds the processing to step S17. Next, in step S17, the ECU 20 performs the offset control, and terminates this processing.

Note that in a case where the set value of the distance to the static target is changed in step S19, for example, the set value may be changed by using a lower limit smaller than the range between LS1 and LS3, in addition to the range (the range between LS1 and LS3) based on the set value LS1 of the distance (large), the set value LS2 of the distance (middle), and the set value LS3 of the distance (small) shown in FIG. 2A. For example, the distance to the static target (LS) may be set in a range that is larger than zero, and is smaller than the set value LS3 of the distance (small) (0<LS<LS3). By performing the offset control so as to secure the distance in the horizontal direction set to the dynamic target, while avoiding interference (contact) with the static target with height, such as, for example, a pylon, a traffic signal, a telephone pole supporting a traffic signal, a curbstone, and a road structure such as a sign and a guardrail, by using a value larger than zero, it is possible to travel with a safer sense of distance without excessive deceleration.

The vehicle control apparatus of the present embodiment can control automated driving of a vehicle based on a set automated-driving level. For example, there are levels 1 to 4 shown below as the automated-driving levels. It is assumed that the automated-driving level at which surrounding monitoring duty is required for the driver is a low-level automated-driving level, and the automated-driving level that the surrounding monitoring duty required for the driver is more relaxed than the low-level automated-driving level is a high level automated-driving level.

During automated driving at the set automated-driving level, the ECU 20 can change the offset amount according to the automated-driving level. For example, in a case where the distance (small) is set as the offset amount for the dynamic target or the static target, the ECU 20 can set the offset amount in the high-level automated driving larger than the offset amount in the low-level automated driving. For example, it is possible to set the offset amount in the automated driving at a level 3 larger than the offset amount in the automated driving at a level 2.

The change of the offset amount is not limited to this example, and the ECU 20 can set the offset amount according to the levels 1, 2, 3 and 4. In a case of the distance (small) as shown in FIG. 2A, the offset amount to the dynamic target is LD3, and the offset amount to the static target is LS3. On the basis of these offset amounts (LD3, LS3), according to the automated-driving level of the level 1 to 4, the ECU 20 can set the offset amount of the distance (small) as shown in FIG. 2B. That is, the ECU 20 can set LD3-1, LD3-2, LD3-3, and LD3-4 as the offset amount of the distance (small) to the dynamic target according to the automated-driving level. The size relationship among the respective offset amounts can be set such that the respective offset amounts are increased according to the automated-driving levels 1 to 4. That is, the ECU 20 can set LD3-1<LD3-2<LD3-3<LD3-4 as the size relationship among the respective offset amounts.

Additionally, also to the static target, the ECU 20 can similarly set LS3-1, LS3-2, LS3-3, and LS3-4 as the offset amounts of the distance (small) to the static target according to the automated-driving level. The size relationship among the respective offset amounts can be set such that the respective offset amounts are increased according to the automated-driving levels 1 to 4. That is, the ECU 20 can set LS3-1<LS3-2<LS3-3<LS3-4 as the size relationship among the respective offset amounts. Note that the size relationship may be the opposite. Additionally, the change of the offset amount is not limited to the case of the distance (small), and the same applies to the cases of the distance (large) and the distance (middle).

Additionally, the ECU 20 can change the offset amount depending on whether the detection result is a hands-on state where the driver is holding a steering wheel 31, or a hands-off state (hands-free state) where the driver is not holding the steering wheel 31.

The ECU 21, which controls the electric power steering apparatus 3, can highly accurately determine whether it is in the hands-on state or in the hands-off state, based on the detection result of a sensor provided in the steering wheel 31. The sensor includes an electrostatic capacity sensor, a resistive sensor, a piezoelectric sensor, a temperature sensor, etc. For example, when a piezoelectric sensor is compressed, a voltage signal is generated, and voltage is detected by a detection circuit of the ECU 21. The other kinds of sensors depend on electric or magnetic signals caused by contact, and the signals of the sensors are detected by detection circuits of the ECU 21 corresponding to the respective sensors.

The ECU 20 can change the offset amount based on the detection result of the hands-on state or the hands-off state by the ECU 21. As shown in FIG. 2B, in the case of the distance (small), the offset amount to the dynamic target at the level 2 is LD3-2, and the offset amount to the static target is LS3-2. Additionally, the offset amount to the dynamic target at the level 3 is LD3-3, and the offset amount to the static target is LS3-3. On the basis of these offset amounts (LD3-2, LS3-2, LD3-3, LS3-3), the ECU 20 can set the offset amounts of the distance (small) as shown in FIG. 2C, based on the detection result of the hands-on state or the hands-off state.

In the hands-on state at the level 2, the ECU 20 can set LD3-2-ON as the offset amount of the distance (small) to the dynamic target, and can set LS3-2-ON as the offset amount of the distance (small) to the static target. Additionally, in the hands-off state at the level 2, the ECU 20 can set LD3-2-OFF as the offset amount of the distance (small) to the dynamic target, and can set LS3-2-OFF as the offset amount of the distance (small) to the static target.

In the size relationship among the offset amounts, the offset amounts (LD3-2-OFF, LS3-2-OFF) in the hands-off state can be set larger than the offset amounts (LD3-2-ON, LS3-2-ON) in the hands-on state. Note that the size relationship may be the opposite. Additionally, the change of the offset amount is not limited to the case of the distance (small), and the same applies to the cases of the distance (large) and the distance (middle).

Also at the level 3, in the hands-on state at the level 3, the ECU 20 can similarly set LD3-3-ON as the offset amount of the distance (small) to the dynamic target, and can set LS3-3-ON as the offset amount of the distance (small) to the static target. Additionally, in the hands-off state at the level 3, the ECU 20 can set LD3-3-OFF as the offset amount of the distance (small) to the dynamic target, and can set LS3-3-OFF as the offset amount of the distance (small) to a static target.

In the size relationship among the offset amounts, the offset amounts (LD3-3-OFF, LS3-3-OFF) in the hands-off state can be set larger than the offset amounts (LD3-3-ON, LS3-3-ON) in the hands-on state. Note that the size relationship may be the opposite. Additionally, the change of the offset amount is not limited to the case of the distance (small), and the same applies to the cases of the distance (large) and the distance (middle).

(Automated-Driving Level)

The automated-driving level is classified into a plurality of stages according to the degree of control by a control unit (for example, the ECU 20) regarding the operation related to acceleration, steering, and braking of a vehicle, and the degree of involvement in the vehicle operation by the driver who operates the vehicle. For example, the following can be listed as automated-driving levels. Note that the following classification is exemplary, and the spirit of the present invention is not limited to this example.

(1) Level 1 (Single-type Automated Driving)

At the level 1, a traveling control apparatus performs operation control of any of acceleration, steering, and braking of a vehicle. For all the operations except for the operations on which the operation control is performed by the traveling control apparatus, the driver's involvement is required, and the driver is always required to be in the state capable of performing safe driving at the level 1 (the surrounding monitoring duty is required).

(2) Level 2 (Composite Automated Driving)

At the level 2, the traveling control apparatus performs operation control of a plurality of acceleration, steering, and braking of the vehicle. Although the degree of involvement by the driver becomes lower than that at the level 1, also in the level 2, the driver is always required to be in the state capable of performing safe driving (the surrounding monitoring duty is required).

(3) Level 3 (Advanced Automated Driving)

At the level 3, the traveling control apparatus performs all the operations related to acceleration, steering, and braking, and only when requested by the traveling control apparatus, the driver correspondingly performs operation of the vehicle. At the level 3, the surrounding monitoring duty for the driver is relaxed while traveling in the automated driving. At the level 3, the degree of involvement by the driver becomes further lower than that at the level 2.

(4) Level 4 (Completely Automated Driving)

At the level 4, the traveling control apparatus performs all the operations related to acceleration, steering, and braking, and the driver is not involved in the operation of the vehicle at all. At the level 4, automated traveling is performed in all the steps in which the vehicle travels, the surrounding monitoring duty for the driver is relaxed while traveling in the automated driving, and the degree of involvement by the driver becomes further lower than that at the level 3.

<Summary of Embodiment>

Configuration 1. The vehicle control apparatus of the above-described embodiment is a vehicle control apparatus (for example, 100) that controls traveling of a vehicle (for example, 1), the vehicle control apparatus characterized by including:

setting means (for example, 28, 92, 93, DISP, UI) for setting a distance in a horizontal direction that crosses a traveling direction of the vehicle to a target that may exist in the surroundings of the vehicle;

detection means (for example, 22, 23, 42, 43) for detecting the target existing in the surroundings of the vehicle while the vehicle is traveling; and

control means (for example, 20, COM) for executing offset control that moves the vehicle in the horizontal direction, based on comparison between a distance in the horizontal direction to the detected target, and the distance in the horizontal direction set to the target.

According to the vehicle control apparatus of Configuration 1, it is possible to control the distance in the horizontal direction that crosses the traveling direction of the vehicle, as the relative positional relationship with respect to the target existing in the surroundings of the vehicle, according to the setting by the driver. Additionally, according to the vehicle control apparatus of Configuration 1, it is possible to perform the automated driving matching the driver's driving feeling.

Configuration 2. The vehicle control apparatus (100) of the above-described embodiment, characterized in that the setting means (28, 92, 93, DISP, UI) sets the distance in the horizontal direction by classifying the distance in the horizontal direction into distance setting to a dynamic target that moves over the passage of time, and distance setting to a static target that does not move over the passage of time.

According to the vehicle control apparatus of Configuration 2, it is possible to perform automated driving on a track that is comfortable for the driver, by setting the distance in the horizontal direction to the dynamic target and the static target in a classified manner according to the driver's driving feel, i.e., by setting the interval to be secured to the target in the horizontal direction by classifying the target according to the type.

Configuration 3. The vehicle control apparatus (100) of the above-described embodiment, characterized in that, in a case where the detection means (22, 23, 42, 43) detects a plurality of targets existing in the surroundings of the vehicle,

the control means (20, COM) executes offset control that moves the vehicle in the horizontal direction, based on comparison between a distance in the horizontal direction to each of the plurality of detected targets, and the distance in the horizontal direction set to the target.

According to the vehicle control apparatus of Configuration 3, it is possible to control the distance in the horizontal direction that crosses the traveling direction of the vehicle, as the relative positional relationship with respect to a plurality of targets existing in the surroundings of the vehicle, according to the setting by the driver.

Configuration 4. The vehicle control apparatus (100) of the above-described embodiment, characterized in that,

in a case where a distance in the horizontal direction to one target of the plurality of targets is secured, the control means (20, COM) determines whether a distance in the horizontal direction between the vehicle and another target is less than a set value of a distance to the other target, and

in a case where the distance in the horizontal direction is less than the set value of the distance to the other target, the control unit (20, COM) performs deceleration control of the vehicle.

According to the vehicle control apparatus of Configuration 4, by decelerating the speed of the traveling vehicle, it is possible to wait in a deceleration state for the dynamic target in the surroundings to move on, and change the positional relationship with the dynamic target traveling side by side. Additionally, by decelerating the vehicle to reduce the kinetic energy of the vehicle, it is possible to further reduce the influence of the vehicle that may occur in interference with a target.

Configuration 5. The vehicle control apparatus (100) of the above-described embodiment, characterized in that the control means (20, COM) performs the offset control in a case where the distance in the horizontal direction between the vehicle and the other target is not less than the set value of the distance to the other target.

According to the vehicle control apparatus of Configuration 5, it is possible to secure the set value of the distance to one of the detected targets.

Configuration 6. The vehicle control apparatus (100) of the above-described embodiment, characterized in that the plurality of targets include a dynamic target that moves over the passage of time, and a static target that does not move over the passage of time, and

in a case where, in a state where the deceleration control is performed, the detected distance in the horizontal direction is less than the set distance in the horizontal direction for at least one of the dynamic target and the static target, the control means (20, COM) temporarily changes the set distance in the horizontal direction to the static target to be small.

According to the vehicle control apparatus of Configuration 6, by temporarily changing the set value of the distance to the static target, it is possible to travel with a safer sense of distance without excessive deceleration, by temporarily permitting it to be less than the distance set to the static target, to secure the set value of distance to the dynamic target.

Configuration 7. The vehicle control apparatus (100) of the above-described embodiment, characterized in that the setting means (for example, 28, 92, 93, DISP, UI) sets distance setting to the static target to be small compared with distance setting to the dynamic target.

According to the vehicle control apparatus of Configuration 7, by performing setting to the dynamic target and the static target according to the driver's driving feeling, it is possible to perform the automated driving matching the driver's driving feeling.

Configuration 8. The vehicle control apparatus (100) of the above-described embodiment, characterized in that the setting means (for example, 28, 92, 93, DISP, UI) classifies the dynamic target into a pedestrian, a bicycle, a motorbike, and a four-wheeled vehicle to set different distances, and

classifies the static target into a static target with height with respect to a road where the vehicle travels, and a static target without height with respect to the road to set different distances.

Configuration 9. The vehicle control apparatus (100) of the above-described embodiment, characterized in that, for the dynamic target, the setting means (for example, 28, 92, 93, DISP UI) sets a distance to the bicycle to be smaller than a distance to the pedestrian, sets a distance to the motorbike to be smaller than the distance to the bicycle, and sets a distance to the four-wheeled vehicle to be smaller than the distance to the motorbike, and

for the static target, the setting means (for example, 28, 92, 93, DISP UI) sets a distance to the static target without height with respect to the road where the vehicle travels to be smaller than a distance to the static target with height with respect to the road.

According to the vehicle control apparatuses of Configuration 8 and Configuration 9, by subclassifying the contents of the dynamic target and the static target, and setting respective different distances, it is possible to perform the automated driving further matching the driver's driving feeling.

Configuration 10. The vehicle (for example, 1) of the above-described embodiment is characterized by including the vehicle control apparatus according to any one configuration of Configuration 1 to Configuration 9.

According to the vehicle of Configuration 10, with the vehicle control apparatus included in the vehicle, it is possible to control the distance in the horizontal direction that crosses the traveling direction of the vehicle, as the relative positional relationship with respect to a target existing in the surroundings of the vehicle, according to the setting by a driver. Additionally, according to the vehicle of Configuration 10, it is possible to provide a vehicle that allows the automated driving matching the driver's driving feeling.

Configuration 11. A vehicle control method of the above-described embodiment is a vehicle control method executed in a vehicle control apparatus that controls traveling of a vehicle, the vehicle control method characterized by including:

setting a distance in a horizontal direction that crosses a traveling direction of the vehicle to a target that may exist in the surroundings of the vehicle (for example, S10);

detecting the target existing in the surroundings of the vehicle while the vehicle is traveling (for example, S11); and

executing offset control that moves the vehicle in the horizontal direction, based on comparison between a distance in the horizontal direction to the detected target, and the distance in the horizontal direction set to the target (for example, S12 to S20).

According to the vehicle control method of Configuration 11, it is possible to control the distance in the horizontal direction that crosses the traveling direction of the vehicle, as the relative positional relationship with respect to the target existing in the surroundings of the vehicle, according to the setting by the driver. Additionally, according to the vehicle control method of Configuration 11, it is possible to perform the automated driving matching the driver's driving feeling.

The present invention is not limited to the above embodiments and various changes and modifications can be made without departing from the spirit and scope of the present invention. Therefore, to apprise the public of the scope of the present invention, the following claims are attached.

What is claimed is:

1. A vehicle control apparatus that controls traveling of a vehicle, the vehicle control apparatus comprising:
a setting unit configured to set a distance in a horizontal direction that crosses a traveling direction of the vehicle to a target that may exist in surroundings of the vehicle;
a detection unit configured to detect the target existing in the surroundings of the vehicle while the vehicle is traveling; and
a control unit configured to execute offset control that moves the vehicle in the horizontal direction, based on comparison between a distance in the horizontal direction to the detected target, and the distance in the horizontal direction set to the target.

2. The vehicle control apparatus according to claim 1, wherein the setting unit sets the distance in the horizontal direction by classifying the distance in the horizontal direction into distance setting to a dynamic target that moves over the passage of time, and distance setting to a static target that does not move over the passage of time.

3. The vehicle control apparatus according to claim 1, wherein, in a case where the detection unit detects a plurality of targets existing in the surroundings of the vehicle,
the control unit executes offset control that moves the vehicle in the horizontal direction, based on comparison between a distance in the horizontal direction to each of the plurality of detected targets, and the distance in the horizontal direction set to the target.

4. The vehicle control apparatus according to claim 3, wherein,
in a case where a distance in the horizontal direction to one target of the plurality of targets is secured, the control unit determines whether a distance in the horizontal direction between the vehicle and another target is less than a set value of a distance to the other target, and
in a case where the distance in the horizontal direction is less than the set value of the distance to the other target, the control unit performs deceleration control of the vehicle.

5. The vehicle control apparatus according to claim 4, wherein the control unit performs the offset control in a case where the distance in the horizontal direction between the vehicle and the other target is not less than the set value of the distance to the other target.

6. The vehicle control apparatus according to claim 4, wherein the plurality of targets include a dynamic target that moves over the passage of time, and a static target that does not move over the passage of time, and
in a case where, in a state where the deceleration control is performed, the detected distance in the horizontal direction is less than the set distance in the horizontal direction for at least one of the dynamic target and the static target, the control unit temporarily changes the set distance in the horizontal direction to the static target to be small.

7. The vehicle control apparatus according to claim 6, wherein the setting unit sets distance setting to the static target to be small compared with distance setting to the dynamic target.

8. The vehicle control apparatus according to claim 6, wherein the setting unit
classifies the dynamic target into a pedestrian, a bicycle, a motorbike, and a four-wheeled vehicle to set different distances, and
classifies the static target into a static target with height with respect to a road where the vehicle travels, and a static target without height with respect to the road to set different distances.

9. The vehicle control apparatus according to claim 8, wherein,
for the dynamic target, the setting unit sets a distance to the bicycle to be smaller than a distance to the pedestrian, sets a distance to the motorbike to be smaller than the distance to the bicycle, and sets a distance to the four-wheeled vehicle to be smaller than the distance to the motorbike, and
for the static target, the setting unit sets a distance to the static target without height with respect to the road where the vehicle travels to be smaller than a distance to the static target with height with respect to the road.

10. A vehicle comprising the vehicle control apparatus according to claim 1.

11. A vehicle control method executed in a vehicle control apparatus that controls traveling of a vehicle, the vehicle control method comprising:
setting a distance in a horizontal direction that crosses a traveling direction of the vehicle to a target that may exist in the surroundings of the vehicle;
detecting the target existing in the surroundings of the vehicle while the vehicle is traveling; and
executing offset control that moves the vehicle in the horizontal direction, based on comparison between a distance in the horizontal direction to the detected target, and the distance in the horizontal direction set to the target.
